(19) United States
(12) Patent Application Publication
(10) Pub. No.: US 2017/0011171 A1
(43) Pub. Date: Jan. 12, 2017

(54) HEALTH MANAGEMENT SYSTEM

(71) Applicants: Mariko MURAKAMI, Osaka (JP); Yoshiki YAMAMOTO, Kanagawa (JP); Shingo TSUKIHARA, Tokyo (JP)

(72) Inventors: Mariko MURAKAMI, Osaka (JP); Yoshiki YAMAMOTO, Kanagawa (JP); Shingo TSUKIHARA, Tokyo (JP)

(21) Appl. No.: 15/259,684

(22) Filed: Sep. 8, 2016

Related U.S. Application Data
(63) Continuation of application No. PCT/JP2014/003535, filed on Jul. 2, 2014.

(30) Foreign Application Priority Data
Mar. 12, 2014 (JP) 2014-049541

(51) Int. Cl. G06F 19/00; G06F 17/30

(52) U.S. Cl. CPC G06F 19/322; G06F 17/30569; G06F 17/30339

(57) ABSTRACT

A health management system that provides a display based on vital data acquired from a subject includes: a vital data storage unit that stores a vital data history; an event storage that stores an event history; a display control unit that displays the vital data history in a first format; a designation accepting unit that accepts a designation operation while the vital data history is displayed in the first format; and a specifying unit that specifies a time related to the accepted designation operation and specifies a time range, during which an influence is exerted by an event that influences vital data corresponding to the specified time, based on the event history and predetermined criteria. When the designation operation is accepted, the display control unit displays the vital data history corresponding to the time range specified by the specifying unit in a second format different from the first format.

### CROSS REFERENCE TO RELATED APPLICATION

This is a continuation application of PCT International Application No. PCT/JP2014/003535 filed on Jul. 2, 2014, designating the United States of America, which is based on and claims priority of Japanese Patent Application No. 2014-049541 filed on Mar. 12, 2014. The entire disclosures of the above-identified applications, including the specifications, drawings and claims are incorporated herein by reference in their entirety.

### FIELD

The present disclosure relates to a health management system for assisting health management and an information processing method that can be used in such a system.

### BACKGROUND

Patent Literature (PTL) 1 discloses a medical information system that displays graph information indicating changes in test results over time, and upon designation of a portion of the graph information, displays information regarding medical actions taken close to the date and time of the designated portion.

### CITATION LIST

### Patent Literature

Japanese Unexamined Patent Application Publication No. 2009-104278

### SUMMARY

### Technical Problem

In order to improve usability of viewers who view health-related information with respect to conventional health management systems, the present disclosure provides a health management system that efficiently displays, to a viewer, health information to which attention needs to be paid, and an information processing method that can be used in this system.

### Solution to Problem

A health management system according to the present disclosure is a health management system that provides a display based on vital data acquired from a subject, the health management system including: a vital data storage unit configured to store a vital data history of vital data associated with a time when the vital data was acquired; an event storage unit configured to store an event history indicating a time of occurrence of an event that possibly influences the vital data; a display control unit, configured to display the vital data history in a first format; a designation accepting unit configured to accept a designation operation while the vital data history is displayed in the first format; and a specifying unit configured to specify a time related to the designation operation accepted by the designation accepting unit and specify a time range, during which an influence is exerted by an event that influences vital data corresponding to the specified time based on the event history and predetermined criteria, wherein the display control unit is configured to, when the designation operation is accepted by the designation accepting unit, display a vital data history corresponding to the time range specified by the specifying unit in a second format that is different from the first format.

Also, an information processing method according to the present disclosure is an information processing method for use in a health management system that includes an apparatus including a storage medium and a processor and that provides a display based on vital data acquired from a subject, the method including the following performed by the processor: storing, in the storage medium, a vital data history of vital data associated with a time when the vital data was acquired and an event history indicating a time of occurrence of an event that possibly influences the vital data; displaying the vital data history in a first format; accepting a designation operation while the vital data history is displayed in the first format; specifying a time related to the accepted designation operation and specifying a time range, during which an influence is exerted by an event that influences vital data corresponding to the specified time, based on the event history; and when the designation operation is accepted, displaying the vital data history corresponding to the specified time range in a second format that is different from the first format.

### Advantageous Effects

The health management system and the information processing method according to the present disclosure are configured to, when a viewer who is viewing health-related information performs an operation to view the information in another display format, display the information by selecting a range to which attention needs to be paid and thus enable the viewer to efficiently view the information.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a schematic configuration diagram of a health management system according to Embodiment 1.

FIG. 2 is a functional block diagram of health management system.

FIG. 3 is a diagram showing a configuration of a vital data history handled by the health management system and an example of the content thereof.

FIG. 4 is a diagram showing a configuration of an event history handled by the health management system and an example of the content thereof.

FIG. 5 is a diagram showing a configuration of detailed information handled by the health management system and an example of the content thereof.

FIG. 6 is a diagram showing a configuration of event criteria information handled by the health management system and an example of the content thereof.

FIG. 7 is a diagram showing a transition of a screen of a subject terminal constituting the health management system.

FIG. 8 is a diagram ho in transition of the screen of the subject terminal.

FIG. 9 is a flowchart illustrating history display processing performed with the subject terminal.

FIG. 10 is a flowchart illustrating display period specifying processing performed with the subject terminal.

FIG. 11 is a flowchart illustrating detailed information display processing performed with the subject terminal.

FIG. 12 is a flowchart illustrating subject input processing performed with the subject terminal.

FIG. 13 is a flowchart illustrating counselor input processing performed with a counselor terminal constituting the health management system.

FIG. 14 is a diagram showing a configuration of event criteria information according to another embodiment and an example of the content thereof.

FIG. 15 is a diagram showing an example of an operation performed on the subject terminal, the operation being an operation to display a table containing several days around a designation day.

FIG. 16 is a diagram showing an example of an operation performed on the subject terminal, the operation being an operation to display a table containing a day on which an event occurred.

FIG. 17 is a diagram showing an example of an operation performed on the subject terminal, the operation being a swipe operation on a graph.

FIG. 18 is a diagram showing an example of an operation performed on the subject terminal the operation being a swipe operation on the graph.

### DESCRIPTION OF EMBODIMENTS

In order to efficiently display health information to which attention needs to be paid when a person who receives health management (hereinafter, referred to as a “subject”) views his/her health-related information (measured values of blood pressure, weight and the like), a health management system according to the present disclosure is a health management system that provides a display based on vital data acquired from a subject, the health management system including: a vital data storage unit configured to store a vital data history of vital data associated with a time when the vital data was acquired; an event storage unit configured to store an event history indicating a time of occurrence of an event that possibly influences the vital data; a display control unit configured to display the vital data history in a first format; a designation accepting unit configured to accept a designation operation while the vital data history is displayed in the first format; an a specifying unit configured to specify a time related to the designation operation accepted by the designation accepting unit and specify a time range, during which an influence is exerted by an event that influences vital data corresponding to the specified time, based on the event history and predetermined criteria, wherein the display control, unit is configured to, when the designation operation is accepted by the designation accepting unit, display a vital data history corresponding to the time range specified by the specifying unit in a second format that is different from the first format. The vital data is acquired by accepting an input of an operation from the subject, receiving from a measurement apparatus that measures the vital data of the subject, and the like. The vital data can be displayed in, for example, a tabulated format, a graph format or the like. Note that the term “time” is a superordinate concept that encompasses all terms of time such as year, month, day and time.

With the health management system, when the subject performs a designation operation to view the data in another display format, the information in a range to which attention needs to be paid is selected and displayed, and thus efficient viewing is possible.

Here, for example, the health management system may be implemented by including a subject terminal and a management apparatus that perform communication with each other, the subject terminal may include the display control unit, the designation accepting unit, and an acquiring unit configured to acquire the vital data and reflect the acquired vital data to the vital data history stored in the vital data storage unit, the management apparatus may include the vital data storage unit and the event storage unit, the first format may be a tabulated format and the second format may be a graph format, and the predetermined criteria may be information indicating a period during which the event influences the vital data

With this configuration, the subject can check individual vital data values in the tabulated format and recognize the tendency of changes in the vital data over time in the graph format by making a designation. Also, the graph is narrowed to a range effective for the subject to recognize the tendency, and thus the subject can accurately recognize the tendency.

Also, for example, the health management system may further include a counselor terminal that performs communication with the management apparatus, the event belongs to one of a plurality of event types, the predetermined criteria may be information indicating, for each event type, a degree of importance of the event and the period during which the event influences the vital data, the counselor terminal may include an input accepting unit configured to accept an input operation for inputting guidance information indicating a guidance instruction provided to the subject based on the vital data stored in the vital data storage unit and an input operation for updating the predetermined criteria, the management apparatus may include a detailed information storage unit configured to store the guidance information, the event types may include health care guidance in which the guidance information is notified to the subject, the event history may indicate, in a case of the event belonging to the health care guidance, a time when the guidance information was notified to the subject and includes information being associated with the guidance information stored in the detailed information storage unit, and the display control unit may be configured to display the guidance information if a predetermined condition is satisfied.

With this configuration, when the counselor provides a health care guidance to the subject, the subject can efficiently recognize, from the graph, the tendency of changes in the vital data that have been made since the health care guidance was provided.

Also, the acquiring unit may be further configured to: acquire event information regarding an event related to an activity input by the subject and update the event history stored in the event storage unit based on the event information; and when the event information acquired by the acquiring unit includes a comment regarding the event, store the comment in the detailed information storage unit, when there is a comment regarding the event related to the activity, the event history may include information that is associated with the comment stored in the detailed information storage unit, and the display control unit may be configured to display the comment if a predetermined condition is satisfied.

With this configuration, the subject can input and view comments regarding the event related to an activity such as physical exercise, eating-out or restricted diet.

Also, the designation accepting unit may be configured to also, accept a designation operation when the vital data history is displayed in the graph format and the display control unit may be configured to: display the vital data history with a display object indicating the time of occurrence of the event when displaying the vital data history in the graph format; and when a designation operation for designating the display object is accepted by the designation accepting unit, determine that the predetermined condition has been satisfied.

With this configuration, the subject can view comments and the like regarding the event by designating the display object indicating the time of occurrence of the event in the graph,

Also, the designation accepting unit may be configured to also accept a designation operation when the vital data history is displayed in the graph format, and the display control unit may be configured to display the vital data history corresponding to the time range specified by the specifying unit in the tabulated format when the designation operation is accepted by the designation accepting unit while the vital data history is displayed in the graph format.

With this configuration, the subject can make a designation while the graph is displayed so as to display a table.

Also, the acquiring unit may be further configured to acquire event information regarding an event related to an activity input by the subject and reflect the acquired event information to the event history stored in the event storage unit.

With this configuration, the subject can input and view an event.

Also, the acquiring unit may be further configured to accept an input operation for updating the predetermined criteria and update the predetermined criteria.

With this configuration, the subject can update the criteria for narrowing the vital data history and displaying the narrowed vital data history.

Also, the health management system may be implemented by including a subject terminal and a management apparatus that perform communication with each other, the subject terminal may include the display control unit, the designation accepting unit, and an acquiring unit configured to acquire the vital data and reflect the acquired vital data to the vital data history stored in the vital data storage unit, the management apparatus may include the vital data storage unit and the event storage unit, the first format may be a graph format and the second format may be a tabulated format, and the predetermined criteria may be information indicating a period during which the event influences the vital data.

With this configuration, the subject can recognize the change in the vital data over time in the graph format, and check vital data values to which attention needs to be paid in the tabulated format by making a designation.

Also, the first format may be a tabulated format and the second format may be a graph format. The predetermined criteria may be information indicating a period during which the event influences vital data. The specifying unit may be configured to, when the designation accepting unit accepts a designation operation for designating vital data while the vital data history is displayed in the tabulated format, specify a time when the vital data designated by the designation operation was acquired, and if the time is included in a period during which an influence is exerted by an event that occurred prior to the time, specify the period as the time range.

With this configuration, the subject can check individual vital data values in the tabulated format and, a graph narrowed to a range effective for the subject to recognize the tendency of changes in the vital data over time is displayed through designation of one vital data, and thus the subject can accurately recognize the tendency.

Also, the event may belong to one of a plurality of event types, the predetermined criteria may be information indicating, for each event type, a degree of importance of the event and a period during which the event influences the vital data, and the specifying of the time range performed by the specifying unit may be specifying of a time range, during which an influence is exerted by an event having a highest degree of importance among events that influence vital data corresponding to the time related to the designation operation.

With this configuration, a vital data history to which attention needs to be paid due to the influence of an important event is selected and displayed, and thus the subject can efficiently view the vital data history.

Also, the display control unit may be configured to, when displaying the vital data history in the second format, hide at least a portion of a display region in which the vital data history is already displayed in the first format and display the vital data history in the second format on the hidden portion.

With this configuration, a limited display region on the display device or the like can be effectively used.

Also, an information processing method that can be used in a health management system according to the present disclosure is an information processing method for use in a health management system that includes an apparatus including a storage medium and a processor and that provides a display based on vital data acquired from a subject, the method including the following performed by the processor: storing, in the storage medium, a vital data history of vital data associated with a time when the vital data was acquired and an event history indicating a time of occurrence of an event that possibly influences the vital data; displaying the vital data history in a first format; accepting a designation operation while the vital data history is displayed in the first format; specifying a time related to the accepted designation operation and specifying a time range, during which an influence is exerted by an event that influences vital data corresponding to the specified time, based on the event history; and when the designation operation is accepted, displaying the vital data history corresponding to the specified time range in a second format that is different from the first format.

Also, a control program for an apparatus that can be used in a health management system according to the present disclosure is a control program for causing a processor to execute information processing, the processor being included in an apparatus for use in a health management system that provides a display based on vital data acquired from a subject, the information processing including: referencing a vital data history of vital data associated with a time when the vital data was acquired and an event history indicating a time of occurrence of an event that possibly influences the vital data; displaying the vital data history in a first format; accepting a designation operation while the vital data history is displayed in the first format; determining a time related to the accepted designation operation and determining a time range, during which an influence is exerted by an event that influences vital data corresponding to the specified time, based on the event history; and when the designation operation is accepted, displaying a vital data history corresponding to the determined time range in a second format that is different from the first format.

With the control program as well, a range to which attention needs to be paid is selected and displayed when changing the display format of the vital data history, and thus a user of the health management system can efficiently view the vital data history.

The various generic or specific aspects may be implemented by an apparatus, a system, a method, an integrated circuit, a computer program or a computer readable recording medium, or may be implemented by any combination of an apparatus, a system, a method an integrated circuit, a computer program and a recording medium.

Hereinafter, embodiments will be described in detail with reference to the drawings as appropriate. Note that, however, an excessively detailed description may be omitted. For example, a detailed description of the already well-known matters and a redundant description of substantially the same configuration may be omitted. This aims to prevent the following description from being unnecessarily lengthy and to facilitate the understanding of a person having ordinary skill in the art.

Note that the inventors of the present application provide the accompanying drawings and the following description in order for a person having ordinary skill in the art to sufficiently understand the present disclosure, and thus the drawings and the description are not intended to limit the subject matter recited in the appended claims. That is, the numerical values, shapes, materials, structural elements, the arrangement and connection of the structural elements, steps, the processing order of the steps and the like shown in the following description by way of specific examples are merely examples, and therefore they are not intended to limit the subject matter recited in the appended claims. Among the structural elements described in the following embodiments, structural elements not recited in any one of the independent claims of the appended claims are structural elements that can be added arbitrarily. Also, the drawings are schematic diagram and thus are not necessarily true to scale.

### Embodiment 1

In Embodiment 1, a health management system 10 will be mainly described that implements an information processing method for assisting a subject with managing his/her health by presenting a display or the like based on vital data acquired from the subject.

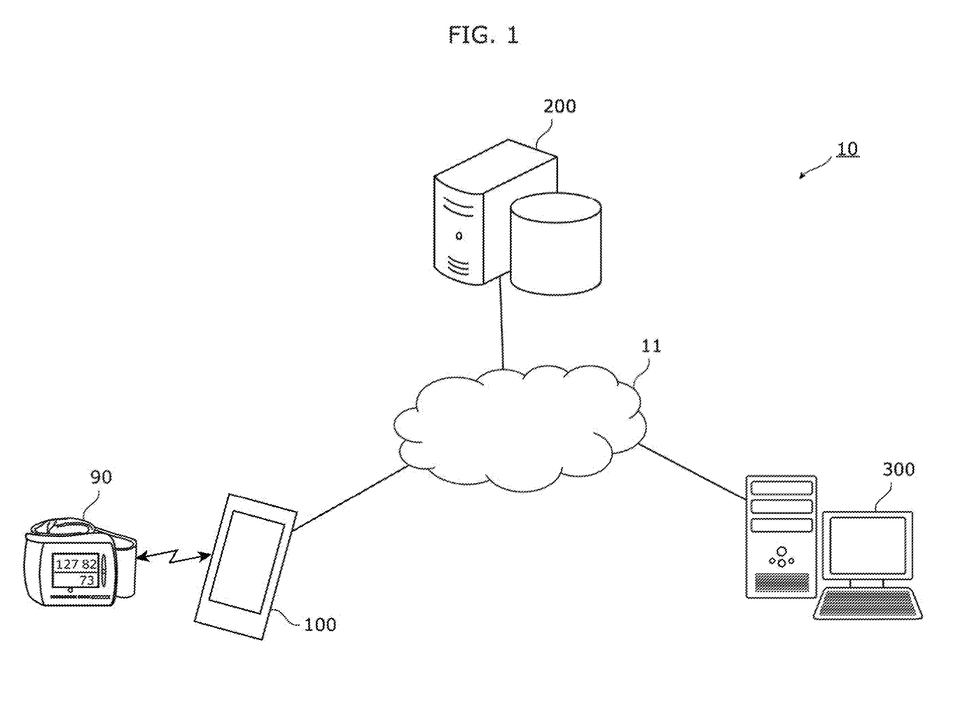

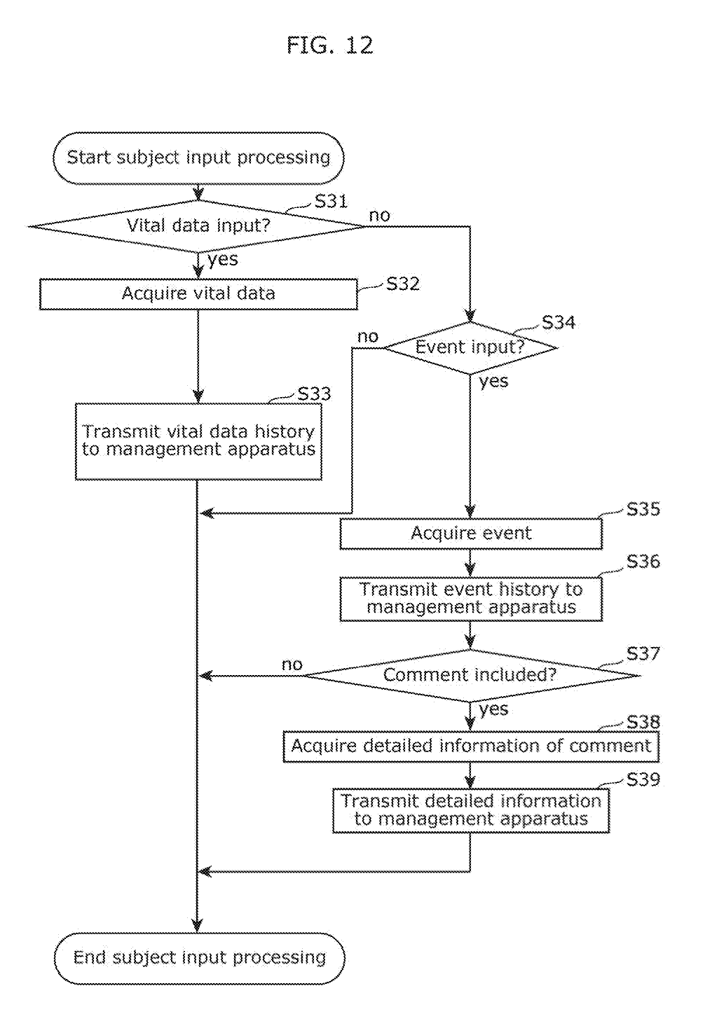

Hereinafter, Embodiment 1 will be described with reference to FIGS. 1 to 13.

[1-1. Configuration]

FIG. 1 is a schematic configuration diagram of a health management system 10 according to Embodiment 1.

As shown in the diagram, the health management system 10 includes a subject terminal 100, a management apparatus 200, a counselor terminal 300, and a network 11 that connects these apparatuses so as to be capable of communication with each other.

The subject terminal 100 is a terminal apparatus such as a smart phone, a tablet or the like operated by a subject, and includes a memory, a processor, an input device, a display device, a communication interface and the like. The memory includes a ROM, a RAM and the like. A control program for implementing the processing of various functional units which will be described later, setting values to be used in the control program, and the like are stored in advance in the memory. Also, the memory is also used to temporarily store values that are used when the control program is executed by the processor. The subject terminal 100 is capable of communication with a measurement apparatus 90 that measures vital data of the subject via wireless communication techniques such as Bluetooth® and Wi-Fi®. The vital data can be so-called biometric information regarding blood pressure, blood sugar level and the like, information regarding the amount of physical activity such as the number of steps of walking, information regarding physical characteristics such as weight, and the like.

The management apparatus 200 is a server apparatus including a memory, a processor, a relatively high capacity storage medium such as a hard disk device, a communication interface, and the like.

The counselor terminal 300 is a terminal apparatus operated by a person who provides a health care guidance from a remote location to the subject (hereinafter referred to as a “counselor ”) and includes a memory, a processor, an input device, a display device, a communication interface, and the like.

An example of usage of the health management system 10 is as follows, for example. First, for example, vital data which is measured values of the subject is transmitted from the subject terminal 100 to the management apparatus 200 and stored in the management apparatus 200. A counselor downloads the vital data of the subject from the management apparatus 200 to the counselor terminal 300 so as to view the vital data. If necessary, the counselor provides a health care guidance to the subject through a telephone or the like (for example, a video call via the network 11, transmission of guidance information by way of the management apparatus 200, a landline telephone that does not use the network 11, or the like), and then inputs the content of the health care guidance to the counselor terminal 300 and uploads the content of the health care guidance to the management apparatus 200. When the subject operates the subject terminal 100 so as to view a vital data history (previous measurement results), the vital data history downloaded from the management apparatus 200, the content of the health care guidance input by the counselor, and the like are displayed on the subject terminal 100.

Hereinafter, the apparatuses constituting the health management system 10 described above will be described in detail.

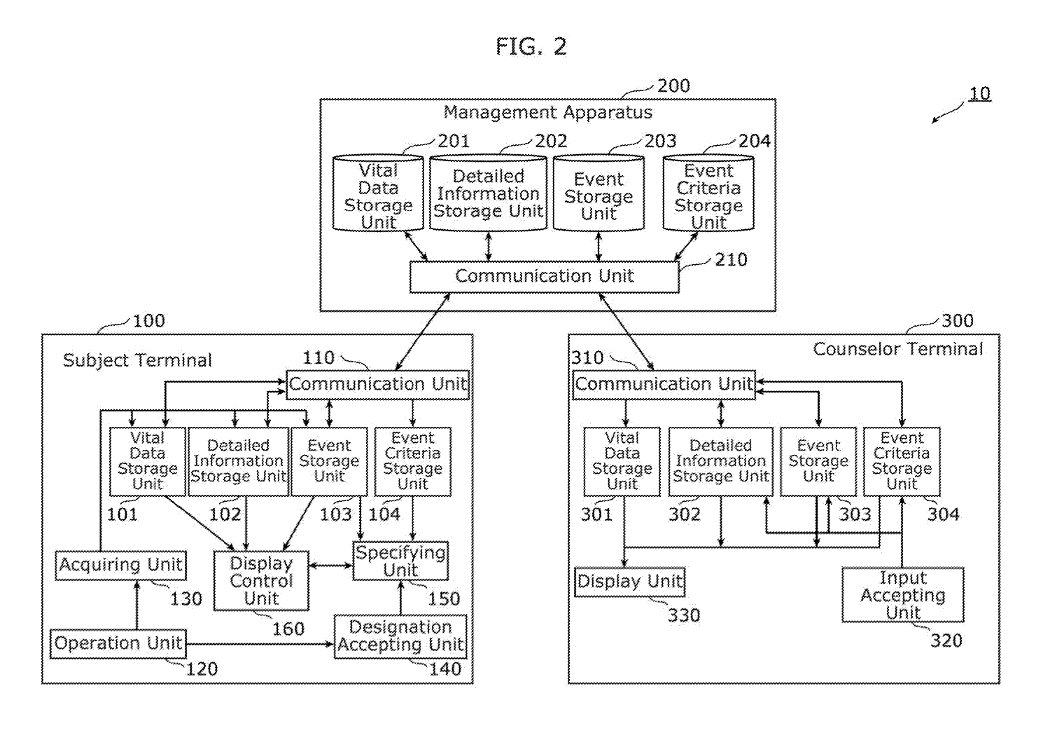

FIG. 2 is a functional block diagram of the health management system 10.

[1-1-1 Functional Configuration of Subject Terminal]

As shown in FIG. 2, the subject terminal 100 includes functional units such as a vital data storage unit 101, a detailed information storage unit 102, an event storage unit 103, an event criteria storage unit 104, a communication unit 110, an operation unit 120, an acquiring unit 130, a designation accepting unit 140, a specifying unit 150 and a display control unit 160. These functional structural elements will be described below

The vital data storage unit 101 is configured as an area of the memory, and has a function of storing a vital data history indicating the records of vital data.

The detailed information storage unit 102 is configured as an area of the memory, and has a function of storing detailed information indicating the details of events. The events as used herein refer to phenomena that possibly influence vital data such as, for example, health care guidance, physical exercise and eating-out.

The event storage unit 103 is configured as an area of the memory, and has a function of storing an event history indicating the records of events.

The event criteria storage unit 104 is configured as an area of the memory, and has a function of storing event criteria information indicating predetermined criteria used to select a vital data display duration period. The event criteria information indicates a period during which an event influences vital data.

The communication unit 110 is implemented by a communication interface such as a communication circuit, and has a function of performing communication with the management apparatus 200 via the network 11 in accordance with a predetermined communication protocol. The communication unit 110 uploads the content stored in the vital data storage unit 101, the detailed information storage unit 102 and the event storage unit 103 to the management apparatus 200. Also, the communication unit 110 downloads the content stored in a vital data storage unit 201, a detailed information storage unit 202, an event storage unit 203 and an event criteria storage unit 204 included in the management apparatus 200 to the subject terminal 100 where necessary.

The operation unit 120 is configured by an input device such as a touch panel, a keyboard or a pointing device, and has a function of accepting an input operation from the user (subject). In the case where the input device is a touch panel, the touch panel may be disposed on the surface of the display device.

The acquiring unit 130 has a function of acquiring information input via the operation unit 120 such as vital data, events and detailed information. Also, the acquiring unit 130 includes a near field wireless communication circuit such as Bluetooth®, and also has a function of, when vital data is transmitted from the measurement apparatus 90, receiving and acquiring the transmitted vital data. When subject input processing (described later) executed with the subject terminal 100 so as to address the input from the subject is performed, the acquiring unit 130 stores the acquired information into the vital data storage unit 101, the detailed information storage unit 102 or the event storage unit 103.

The designation accepting unit 140 has a function of, when a designation operation is performed while vital data is displayed on the display device, accepting the designation operation via the operation unit 120 and notifies the specifying unit 150 of the designation operation.

The specifying unit 150 has a function of when the designation accepting unit 140 accepts a designation operation, specifying a period (a time range during which attention needs to be paid by the subject) that needs to be displayed next based on the event history and the event criteria information. The period that needs to be displayed is specified based on the determination of the date on which vital data related to the accepted designation was acquired, and the period during which an influence is exerted by an event that influences the vital data corresponding to the determined date is specified as the period that needs to be displayed.

The display control unit 160 has a function of generating screen data used to input vital data, screen data for displaying a vital data history and the like in a tabulated format or a graph format, and the like and displaying the generated data on the display device. The display control unit 160 serves as the leading role in history display processing (described later) executed with the subject terminal 100 to display a vital data history and the like.

The functions of the acquiring unit 130, the designation accepting unit 140, the specifying unit 150 and the display control unit 160 are implemented by the processor executing the control program stored in the memory.

[1-1-2. Functional Configuration of Management Apparatus]

The management apparatus 200 includes, as shown in FIG. 2, functional units such as a vital data storage unit 201, a detailed information storage unit 202, an event storage unit 203, an event criteria storage unit 204 and a communication unit 210. Hereinafter, these functional structural elements will be described.

The vital data storage unit 201 is configured as an area of the storage medium such a hard disk device, and has a function of storing vital data histories.

The detailed information storage unit 202 is configured as an area of the storage medium such as a hard disk device, and has a function of storing detailed information.

The event storage unit 203 is configured as an area of the storage medium such as a hard disk device, and has a function of storing event histories.

The event criteria storage unit 204 is configured as an area of the storage medium such as a hard disk device and has a function of storing event criteria information.

The communication unit 210 is implemented by a communication interface such as a communication circuit, and has a function of perform in communication with the subject terminal 100 or the counselor terminal 300 via the network 11 in accordance with a predetermined communication protocol. That is, the communication unit 210 controls the transmission of data stored in the vital data storage unit 201, the detailed information storage unit 202, the event storage unit 203 and the event criteria storage unit 204 as well as the reception and storage of data that needs to be stored in these units. This control may be implemented by the processor executing the control program stored in the memory of the management apparatus 200.

[1-1-3. Functional Configuration of Counselor Terminal]

The counselor terminal 300 includes, as shown in FIG. 2, functional units such as a vital data storage unit 301, a detailed information storage unit 302, an event storage unit 303, an event criteria storage unit 304, a communication unit 310, an input accepting unit 320 and a display unit 330. Hereinafter, these functional structural elements will be described.

The vital data storage unit 301 is configured as an area of the memory, and has a function of storing vital data histories,

The detailed information storage unit 302 is configured as an area of the memory, and has a function of storing detailed information.

The event storage unit 303 is configured as an area of the memory and has a function of storing event histories.

The event criteria storage unit 304 is configured as an area of the memory, and has a function of storing event criteria information.

The communication unit 310 is implemented by communication interface such as a communication circuit, and has a function of performing communication with the management apparatus 200 via the network 11 in accordance with a predetermined communication protocol.

The input accepting unit 320 is configured by an input device such as a keyboard or a pointing device, and has a function of accepting an input operation from the user (counselor).

The display unit 330 has a function of displaying a vital data history and the like on the display device.

[1-2. Data]

Hereinafter, the data handled by the health management system 10 configured as described above will be described.

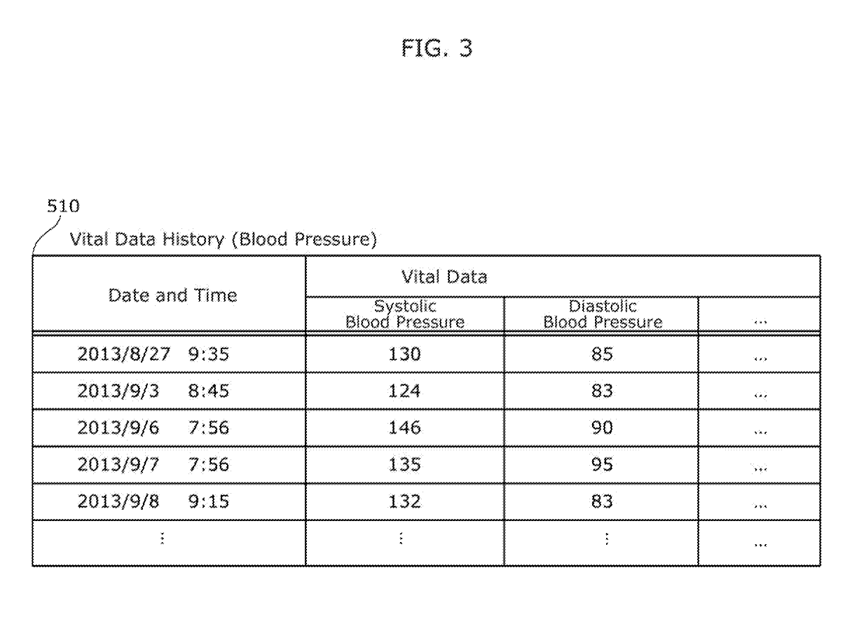

FIG. 3 shows a configuration of a vital data history and an example of the content thereof. The diagram shows vital data regarding blood pressure. As shown in the diagram, the vital data history is information configured by, for each measured (acquired) vital data, associating the vital data (a systolic blood pressure value, a diastolic blood pressure value, and the like) and the date and time at which the vital data was measured (acquired) with each other. That is, the vital data history is a set of records in which the date and time and the vital data are associated with each other. The vital data history is generated by the acquiring unit 130 of the subject terminal 100 that has acquired vital data storing the acquired vital data into the vital data storage unit 101, uploaded to the management apparatus 200, and stored into the vital data storage unit 201. Also, when it is necessary to view the vital data history, all or a part of the vital data history stored in the vital data storage unit 201 is downloaded to the subject terminal 100 or the counselor terminal 300. The downloaded vital data history is stored in the vital data storage unit 101 or the vital data storage unit 301 and used to be displayed on the terminal.

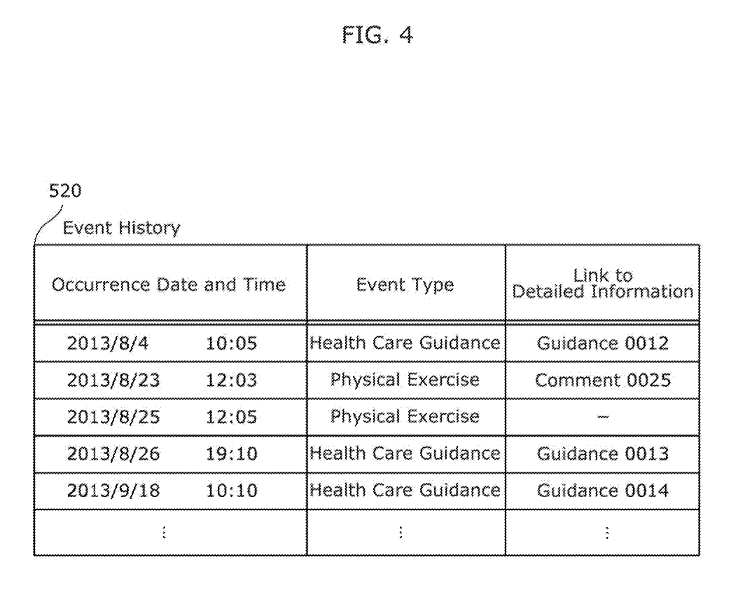

FIG. 4 shows a configuration of an event history and an example of the content thereof. As shown in the diagram, the event history is information configured by, each time an event occurs, associating the date and time of occurrence of the event, the event type and a link leading to detailed information of the event with each other. That is, the event history is a set of records in which the date and time of occurrence of an event, the event type and a link leading to detailed information of the event are associated with each other. As used herein, the event type shows the classification of events such as health care guidance by the counselor (providing a health care guidance), physical exercise related to an activity performed by the subject (carrying out a physical exercise), eating-out (eating outside the home) and restricted diet (eating a restricted diet). Also, the link leading to detailed information is identification information (identification number) for accessing detailed information, and is used only when there is detailed information related to the corresponding event. The event history is generated by the acquiring unit 130 of the subject terminal 100 that has received an input of an event from the subject or the input accepting unit 320 of the counselor terminal 300 that has received an input of an event from the counselor storing the event in the event storage unit 103 or the event storage unit 303. The generated event history is uploaded to the management apparatus 200 and stored into the event storage unit 203. Also, where necessary, the event history stored in the event storage unit 203 is downloaded to the subject terminal 100 or the counselor terminal 300, stored into the event storage unit 103 or the event storage unit 303, and used to be displayed on the terminal.

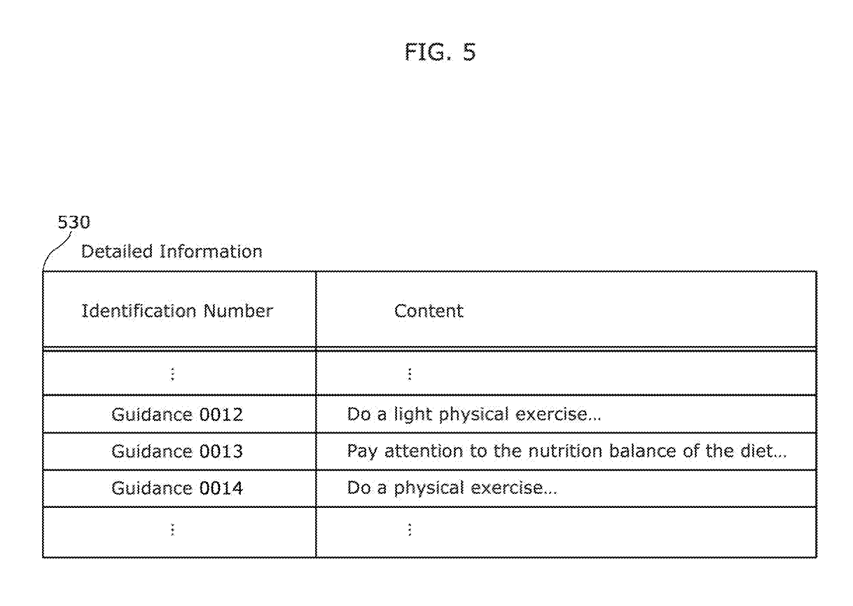

FIG. 5 shows a configuration of detailed information and an example of the content thereof. The detailed information is information indicating details of events. For example, in the case of an event being health care guidance, guidance information indicating a guidance instruction provided by the counselor corresponds to the detailed information. Likewise, in the case of an event related to an activity of the subject (a physical exercise, eating-out or the like), a comment of the subject corresponds to the detailed information. The detailed information is information configured by associating the identification number and the content (a comment, guidance information or the like) with each other, and FIG. 5 shows an example of guidance information input by the counselor. The detailed information is generated by the acquiring unit 130 of the subject terminal 100 that has acquired a comment regarding an event related to an activity of the subject storing the acquired comment into the detailed information storage unit 102, and the generated detailed information is uploaded to the management apparatus 200 and stored into the detailed information storage unit 202. The detailed information is also generated by the input accepting unit 320 of the counselor terminal 300 that has accepted an input of guidance information regarding a health care guidance event storing the accepted guidance information into the detailed information storage unit 302, and the generated detailed information is uploaded to the management apparatus 200 and stored into the detailed information storage unit 202. Also, when it is necessary to view the detailed information, a part of the detailed information stored in the detailed information storage unit 202 is downloaded to the subject terminal 100 or the counselor terminal 300. The downloaded detailed information is stored into the detailed information storage unit 102 or the detailed information storage unit 302, and used to be displayed on the terminal.

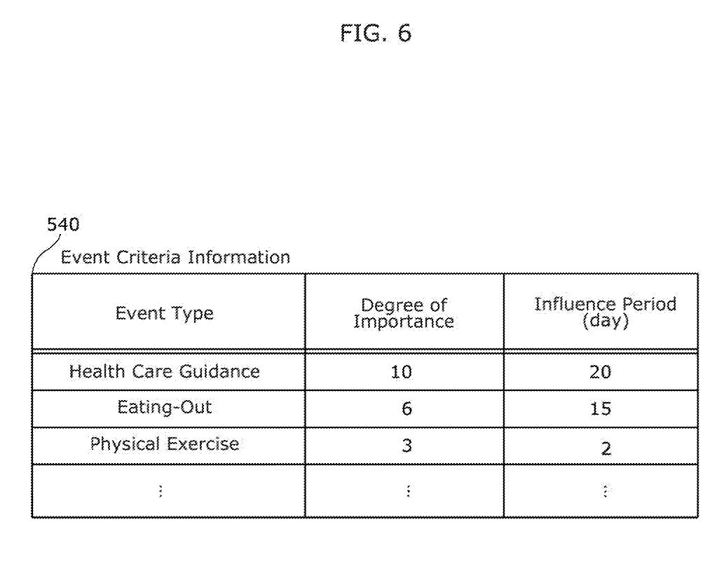

FIG. 6 shows a configuration of event criteria information and an example of the content thereof. As shown in the diagram, the event criteria information is information constituted by associating, for each event type, the event type, the degree of importance and the influence period with each other. As used herein, the degree of importance is information indicating how important each event type is to select a vital data display duration period that needs to be displayed for the subject. Likewise, the influence period is information indicating a period during which it is estimated that the event corresponding to the event type will influence the vital data. The event criteria information is information set by the counselor or the like by taking into consideration, for example, things to which the subject's attention should be drawn from the viewpoint of health management. It is assumed that the counselor or the like sets, as the influence period, a period during which it is estimated that the event will influence the vital data based on experiments, theoretical consideration and the like. The event criteria information is generated by the input accepting unit 320 of the counselor terminal 300 accepting an input from the counselor and storing the accepted input into the event criteria storage unit 304, and the generated event criteria information is uploaded to the management apparatus 200 and stored into the event criteria storage unit 204. Then, where necessary, the event criteria information stored in the event criteria storage unit 204 is downloaded to the subject terminal 100 and used to select a display duration period (time range). Also, where necessary, the event criteria information stored in the event criteria storage Unit 204 is downloaded to the counselor terminal 300 and displayed to be checked by the counselor.

[1-3. Operations]

Hereinafter, the operations of the health management system that is configured as described above and handles the above-described data.

[1-3-1. Operations Performed by Subject]

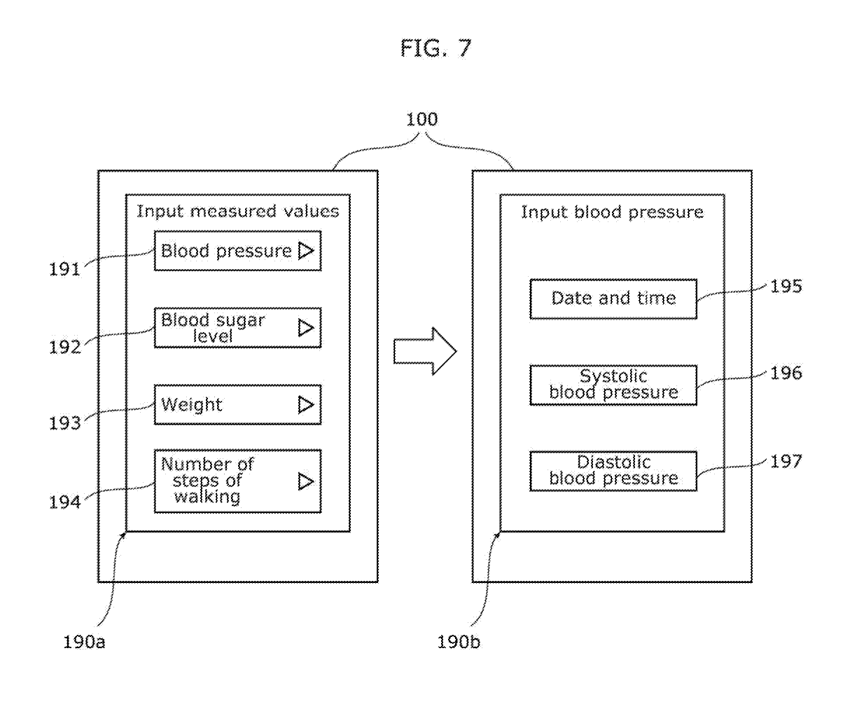

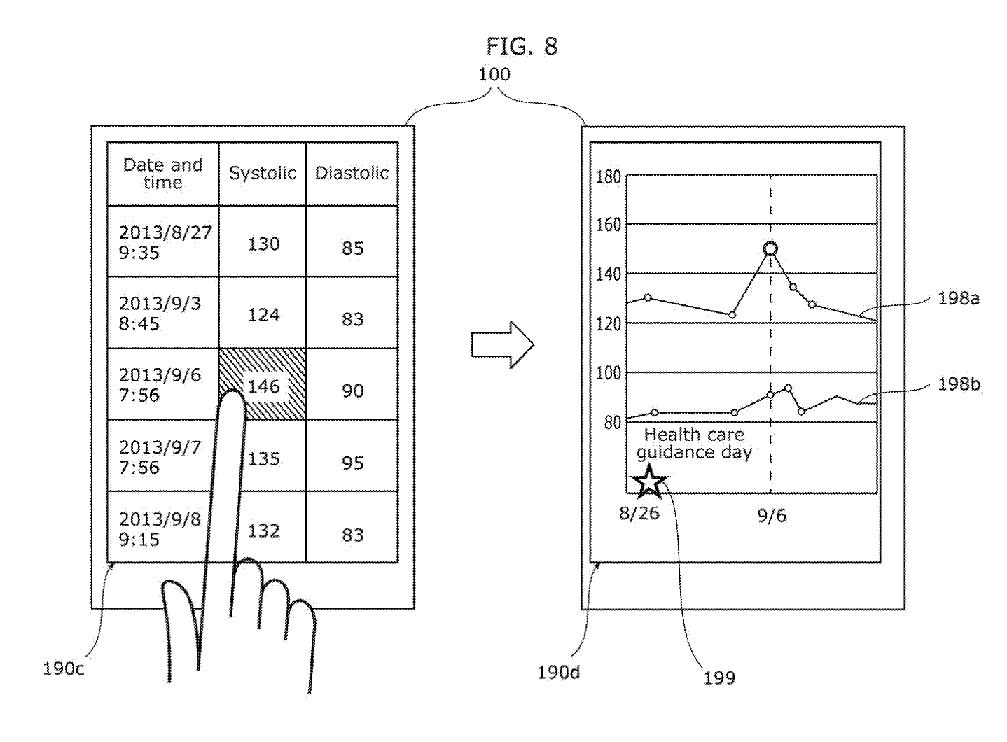

In the subject terminal 100, in response to receiving an input from the subject or the measurement apparatus 90, vital data of the subject, which is a measurement result, is acquired. When the subject wants to view previous measurement results, a vital data history is first displayed in a tabulated format. When the subject who is viewing the vital data history displayed in the tabulated format designates one vital data or the date and time, the subject terminal 100 displays, in a graph format, vital data in a time range (display period) to which the subject should pay attention related to the designation. In this regard, an example of transition of a screen of the subject terminal 100 is shown in FIGS. 7 and 8.

FIG. 7 shows an example of transition from a graphic user interface (GUI) screen 190a displaying a menu used by the subject to input vital data which is measured values to a GUI screen 190b for inputting vital data regarding blood pressure. The screen 190a includes a blood pressure button 191, a blood sugar level button 192, a weight button 193 and a number-of-steps-of-walking button 194. When the user (subject) selects one of the buttons, a screen for inputting detailed items of the vital data is displayed. If the blood pressure button 191 is selected by the subject, the screen 190b is displayed. The screen 190b includes a date/time input'field 195 for inputting the date and time at which blood pressure measurement was conducted, a systolic blood pressure input field 196 for inputting a measured systolic blood pressure and a diastolic blood pressure input field 197 for inputting a measured diastolic blood pressure. The subject selects each input field on the screen 190b to provide an input. The subject can provide an input by using an input device. In the case where an input is provided on a touch panel overlaid on the display device, a configuration may be used in which in response to selection of an input field on the subject terminal 100, a software keyboard, a list containing input candidates, or the like is displayed on the subject terminal 100 so as to facilitate the input operation. Upon completion of the input operation, the input vital data (partial vital data history) is uploaded from the subject terminal 100 to the management apparatus 200. The date and time at which the input operation is performed may be automatically input to the date/time input field 195 as the initial value. Also, in the case where measured vital values are transmitted from the measurement apparatus 90 via wireless communication or the like, the vital values may be automatically input into the systolic blood pressure input field 196 and the diastolic blood pressure input field 197.

FIG. 8 shows an example of transition from a screen 190c displaying a vital data history regarding blood pressure in a tabulated format to a screen 190d displaying the vital data history in a graph format When the subject performs a predetermined operation to view measured values (for example, when the input of the vital data regarding blood pressure described above has been finished, or the like), the subject terminal 100 downloads a vital data history (see FIG. 3) from the management apparatus 200. Then, the subject terminal 100 generates a screen in which the downloaded vital data history is arranged in a tabulated format, and displays the generated screen. As a result, the screen 190c is displayed on the display device. FIG. 8 shows an example in which the screen 190d is displayed in response to designation of one vital data (the systolic blood pressure value measured on Sep. 6, 2013) on the displayed screen 190c by the subject. The screen 190d includes a systolic blood pressure line graph 198a and a diastolic blood pressure line graph 198b generated based on the vital data history of 20 days from the date (Aug. 26, 2013) on which a health care guidance event occurred, which is before Sep. 6, 2013 on which the designation was made. In order to generate the screen 190d, the subject terminal 100 downloads an event history (see FIG. 4) and event criteria information (see FIG. 6) from the management apparatus 200, and determines a time range of the vital data history that needs to be displayed in a graph format by referencing the event history and the event criteria information that have been downloaded. On the screen 190d, an event occurrence mark 199 in the form of a star is displayed on the area indicating Aug. 26, 2013 in the graph.

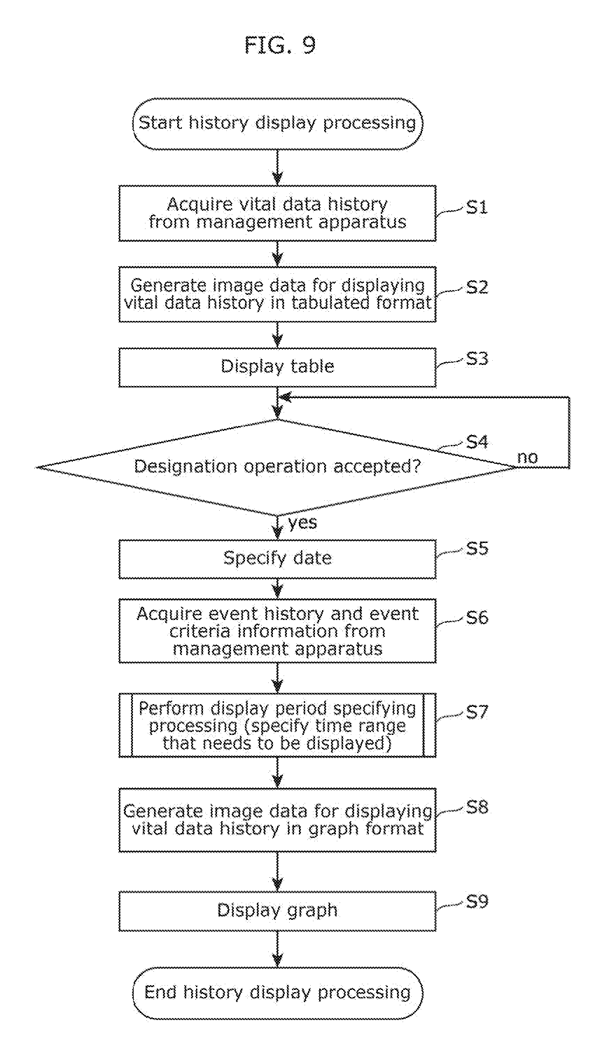

Hereinafter, the operations of the subject terminal 100 will be described with reference to the flowcharts shown in FIGS. 9 to 12.

FIG. 9 is a flowchart illustrating history display processing. When the subject performs a predetermined operation to view measured values, the subject terminal 100 executes the history display processing shown in FIG. 9. Here, the description will be given based on the assumption that a vital data history 510, an event history 520, detailed information 530 and event criteria information 540 shown in FIGS. 3 to 6 as examples are stored in the management apparatus 200.

First, the communication unit 110 downloads a vital data history from the management apparatus 200 and stores the downloaded vital data into the vital data storage unit 101 (processing step S1). The display control unit 160 arranges the vital data history stored in the vital data storage unit 101 in a tabulated format and generates screen data (processing step S2). As a result, screen data in which the content (the date and time, measured values, and the like) of the records in the vital data history are organized in rows or columns is generated. Then, the display control unit 160 sends the generated screen data to the display device so that the display device displays the vital data history in the tabulated format (processing step S3). The screen 190c shown in FIG. 8 is an example of a screen of the display device displayed after the processing in processing step S3 is complete. In the case where the vital data history contains a large number of dates and times (a large number of records) and it is not possible to display all of them on the screen of the display device, the display control unit 160 may generate screen data to which a scroll bar or the like for enabling the displayed dates and times (records) to be scrolled has been added.

When the designation accepting unit 140 accepts a designation operation made by the subject while the vital data history is displayed in the tabulated format (processing step S4), the specifying unit 150 specifies the date on which the vital data related to the designation operation was measured (acquired) (hereinafter, referred to as “designation day”) (processing step S5). The designation day is specified by determining which position (which record) was designated by the designation operation based on, for example, the screen data displayed by the display control unit 160. If, for example, the subject touches, on the touch panel, the systolic blood pressure value measured on Sep. 6, 2013 shown in the screen 190c in FIG. 8, Sep. 6, 2013 is specified as the designation day in processing step S5. Then, the communication unit 110 downloads an event history and event criteria information from the management apparatus 200 and stores the downloaded event history and event criteria information into the event storage unit 103 and the event criteria storage unit 104, respectively (processing step S6). The specifying unit 150 performs display period specifying processing for specifying, in the vital data history, a period that needs to be displayed next in a graph format by referencing the event history and the event criteria information that have been downloaded (processing step S7).

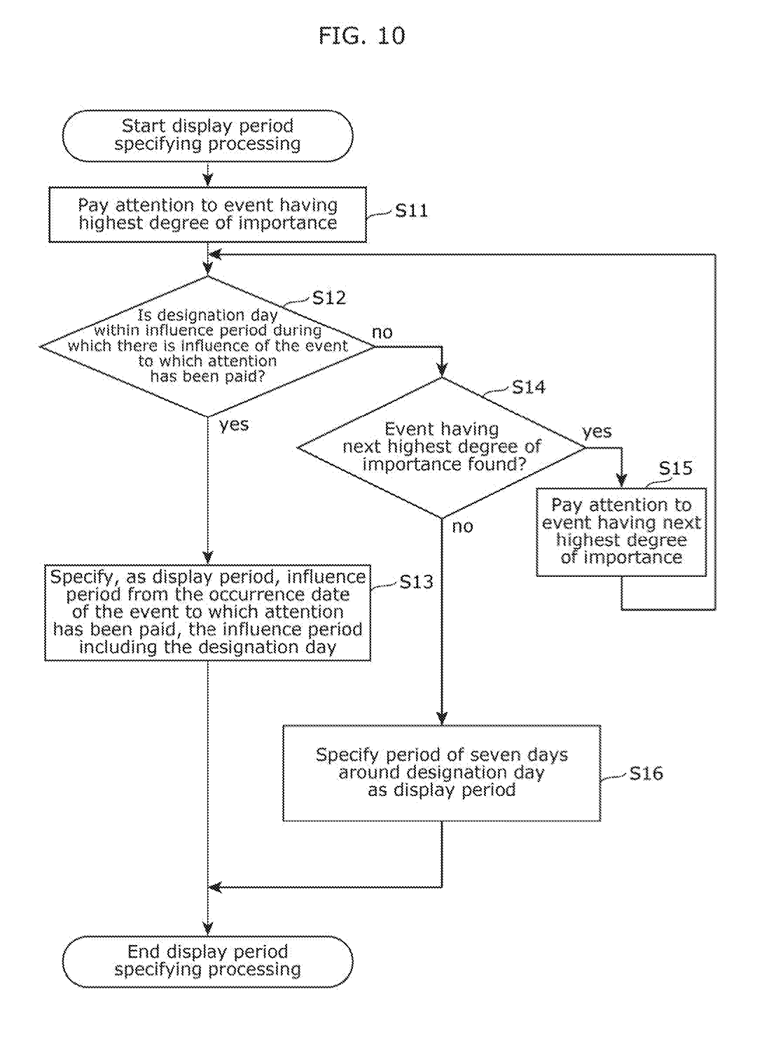

FIG. 10 is a flowchart illustrating display period specifying processing. The specifying unit 150 first pays attention to an event having the highest degree of importance by referencing the downloaded event criteria information (processing step S11) and determines whether the designation day is included within the period (influence period) during which an influence is exerted by the event to which attention has been paid by also referencing the event history (processing step S12). In the event criteria information 540 shown in FIG. 6 as an example, the event type having the highest degree of importance is health care guidance, and the influence period is 20 days. In this case, the designation day (Sep. 6, 2013) is included within 20 days, which is the influence period of the health care guidance event that occurred on Aug. 26, 2013 (see FIG. 4), and thus an affirmative determination is made in processing step S12 and the processing in step S13 is executed. That is, the specifying unit 150 specifies, as the display period, an influence period from the date of occurrence of the event to which attention has been paid, the influence period including the designation day (processing step S13). If, on the other hand, a negative determination is made in processing step S12, the specifying unit 150 determines whether or not there is an event having the next highest degree of importance (processing step S14). If an event having the next highest degree of importance is found, attention is paid to the event having the next highest degree of importance, and the procedure returns to the determination processing in processing step S12 (processing step S15). If, on the other hand, a negative determination is made in processing step S14, the specifying unit 150 specifies a period of seven days around the designation day as the display period (processing step S16). The period of seven days is merely an example, and the number of days may be set to any other value. Through the display period specifying processing described above, the specifying unit 150 specifies, to the extent possible, a period during which an influence is exerted by an event having the highest degree of importance among the events that influence the vital data corresponding to the designation day.

After the display period has been specified by the specifying unit 150 in the manner described above, the display control unit 160 arranges a portion within the display period in the vital data history stored in the vital data storage unit 101 in a graph format and generates screen data (FIG. 9, processing step S8). As a result, screen data indicating a graph showing changes in the vital data over time is generated based on the vital data history such as, for example, a two-dimensional (two-axis) graph with the date and time on one axis and the measured values such as systolic blood pressure values and diastolic blood pressure values on the other axis. Then, the display control unit 160 sends the generated screen data to the display device so that the display device displays the vital data history in the graph format (processing step S9). The screen 190d shown FIG. 8 Is n example of a screen on the display device displayed after the processing in processing step S9 is complete. When generating screen data to be shown in a graph, the display control unit 160 references the event history and thereby adds an event occurrence mark so as to show the area indicating the date and time of occurrence of an event on the graph.

In the manner described above, the subject terminal 100 displays a vital data history in a tabulated format, and thus the subject can check each value in the measured vital data. Also, when the subject performs a designation operation to designate one vital data value or the like, the subject terminal 100 displays the vital data history in a predetermined narrowed time range in a graph format. Accordingly, the subject can easily recognize the tendency of the vital data. The vital data history displayed in a graph format is narrowed to a portion in the display period to which attention needs to be paid according to the event criteria information set by the counselor or the like, and thus the subject can accurately recognize the tendency of the vital data. For example, it is considered that as a result of receiving a health care guidance from the counselor, the subject may change his/her habits, lifestyle and the like. In order for the subject to accurately recognize the tendency of the vital data near the designation day, the vital data history before the health care guidance may be a nuisance for the subject. The counselor can set event criteria information, which is predetermined criteria for selecting a display period, by taking into consideration things to which the subject's attention should be drawn from the viewpoint of health management. The event criteria information may be set individually according to blood pressure, blood sugar level, weight and the number of steps of walking. In this case, if, for example, the vital data of blood sugar level can be influenced more by a physical exercise than by a health care guidance, the degree of importance of the physical exercise can be set higher than the degree of importance of the health care guidance.

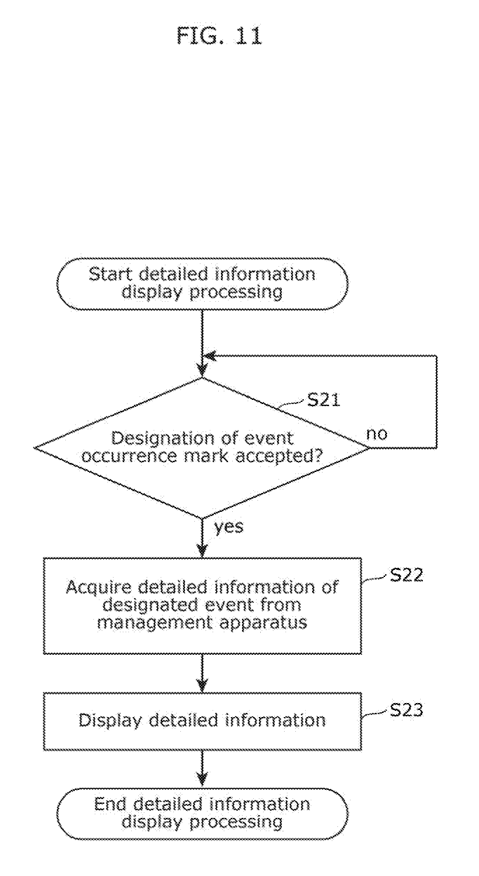

FIG. 11 is a flowchart illustrating detailed information display processing. The detailed information display processing is executed when a predetermined operation is performed such as when the event occurrence mark displayed on the screen is touched. For example, the detailed information display processing is executed when the event occurrence mark 199 displayed on the screen 190d shown in FIG. 8 is designated (touched) by the subject.

In response to the operation unit 120 of the subject terminal 100 accepting the designation of the event occurrence mark (processing step S21), the display control unit 160 downloads and acquires detailed information from the management apparatus 200 via the communication unit 110 (processing step S22). Then, the display control unit 160 displays the detailed information based on the link (see FIG. 4) leading to the detailed information of the event indicated by the designated event occurrence mark (processing step S23). Accordingly, when the event occurrence mark 199 is designated by the subject, a message such as, for example, “pay attention to the nutrition balance of the diet . . . ” (see FIGS. 4 and 5) is displayed on the display device of the subject terminal 100. The detailed information may be guidance information input by the counselor or may be comments input by the subject. If the designated event occurrence mark is displayed so as to correspond to an event related to a comment of the subject, the comment is displayed. As a result, the subject can check the details of the content of the event.

FIG, 12 is a flowchart illustrating subject input processing. The subject input processing is executed when the acquiring unit 130 accepts an input from the subject via the operation unit 120. If the data input by the subject is vital data (processing step S31), the acquiring unit 130 acquires the vital data and stores a vital data history (one record based on the vital data) into the vital data storage unit 101 (processing step S32). Subsequently, the communication unit 110 of the subject terminal 100 transmits the vital data history to the management apparatus 200 (processing step S33). If the data input by the subject is an event (for example, physical exercise, eating-out, restricted diet or the like) (processing step S34), the acquiring unit 130 acquires the event and stores an event history (one record) into the event storage unit 103 (processing step S35). Subsequently, the communication unit 110 transmits the event history to the management apparatus 200 (processing step S36). If the input data contains a comment (processing step S37), the acquiring unit 130 acquires the comment and stores the comment into the detailed information storage unit 102 (processing step S38). Subsequently, the communication unit 110 transmits the detailed information to the management apparatus 200 (processing step S39). In the manner as described above, the data input by the subject is transmitted to and stored in the management apparatus 200. The communication unit 110 may be configured to, instead of transmitting the data stored in the vital data storage unit 101, the detailed information storage unit 102 and the event storage unit 103 to the management apparatus 200 in processing steps S33, S36 and S39 of the subject input processing, transmit the data to the management apparatus 200 at a specific timing such as a fixed time cycle. In the management apparatus 200, the received vital data history, detailed information and event history are stored into the vital data storage unit 201, the detailed information storage unit 202 and the event storage unit 203, respectively.

[1-3-2. Operations Performed by Counselor]

The counselor operates the counselor terminal 300 to view the vital data history of the subject, provides a health care guidance to the subject, and makes an input related to the health care guidance event. Also, the counselor can change the event criteria information through operation of the counselor terminal 300.

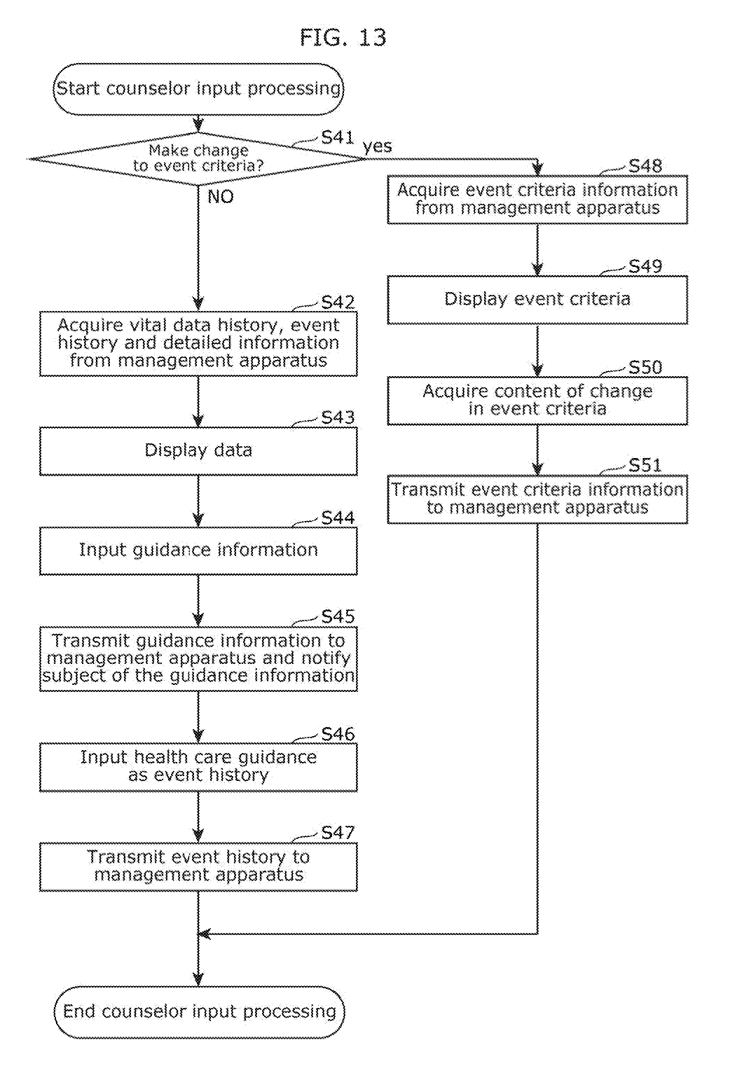

FIG. 13 is a flowchart illustrating counselor input processing. The counselor terminal 300 displays, for example, a menu screen or the like, prompts the counselor to select one of an operation to change the event criteria information, an operation to view the vital data history of the subject so as to provide a health care guidance, and an operation to input guidance information, and then executes the counselor input processing.

If the counselor selects an operation to change the event criteria information (processing step S41), the communication unit 310 downloads the event criteria information from the management apparatus 200 and stores the downloaded event criteria information into the event criteria storage unit 304 (processing, step S48). Then, the display unit 330 displays event criteria shown in the event criteria information on the display device (processing step S49). After that, the content of a change in the event criteria input by the counselor is acquired through the input accepting unit 320, the event criteria information stored in the event criteria storage unit 304 is updated (processing step S50), and the event criteria information is transmitted to the management apparatus 200 (processing step S51). Meanwhile, in the management apparatus 200, the received event criteria information is stored into the event criteria storage unit 204.

If the counselor selects an operation to view the vital data history of the subject so as to provide a health care guidance (processing step S41), the communication unit 310 downloads the vital data history, the event history and the detailed information from the management apparatus 200 (processing step S42). The downloaded data are stored into the vital data storage unit 301, the event storage unit 303 and the detailed information storage unit 302, respectively. Then, the display unit 330 displays the downloaded data on the display device (processing step S43). The display format used to display the data in processing step S43 may be either a tabulated format or a graph format, or the data may be displayed in the two formats. The counselor who is viewing the displayed data inputs guidance information, which is the content of the health care guidance, into the counselor terminal 300. The input accepting unit 320 accepts an input of the guidance information from the counselor (processing step S44), and the guidance information is stored into the detailed information storage unit 302 as detailed information (processing step S45). The communication unit 310 of the counselor terminal 300 transmits the detailed information (guidance information), which is the data stored in the detailed information storage unit 302, to the management apparatus 200 and notifies the subject terminal 100 of the detailed information (processing step S45). The detailed information may be acquired by the subject terminal 100 from the management apparatus 200. Furthermore, as the health care guidance, instead of transmitting guidance information to the subject terminal 100 via the management apparatus 200, the guidance information may be provided through audio such as a video call via a network or a telephone. In this case, however, the guidance information, which is the content of the health care guidance provided to the subject from the counselor, is input and uploaded from the counselor terminal 300, and stored into the detailed information storage unit 202 of the management apparatus 200. Also, a health care guidance event is input by the counselor, and one record of the event history that has been input is acquired by the input accepting unit 320, and then stored into the event storage unit 303 (processing step S46), and the communication unit 310 uploads the event history to the management apparatus 200 (processing step S47). The data input by the counselor in the manner as described above is transmitted to and stored into the management apparatus 200. The communication unit 310 may be configured to, instead of transmitting the data stored in the event storage unit 303 and the event criteria storage unit 304 to the management apparatus 200 in processing steps S47 and S51 of the counselor input processing, transmit the data to the management apparatus 200 at a specific timing such as a fixed time cycle. In the management apparatus 200, the received event history and event criteria information are stored into the event storage unit 203 and the event criteria storage unit 204, respectively.

### Other Embodiments

In the foregoing, Embodiment 1 has been described as an example of the technique disclosed in the present application. However, the technique according to the present disclosure is not limited thereto, and is also applicable to embodiments obtained by making a change, replacement, addition, omission and the like as appropriate.

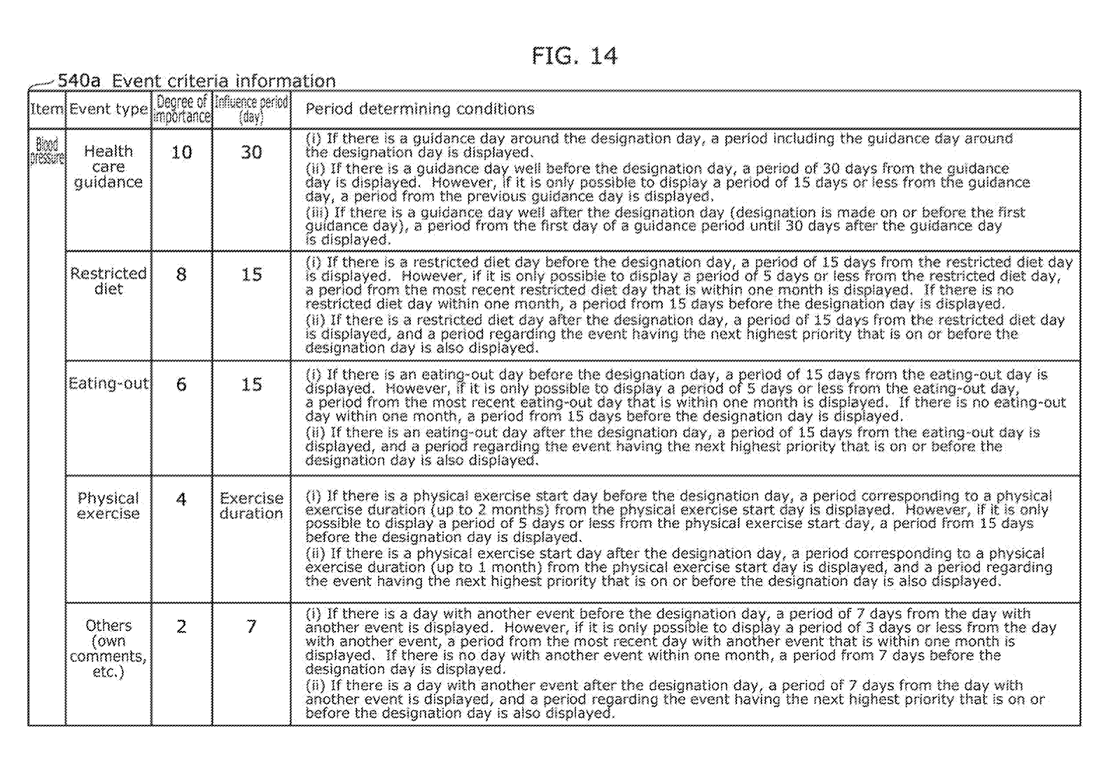

It is sufficient that the event criteria information described in Embodiment 1 functions as predetermined criteria for selecting a display period for showing, to the subject, the tendency of changes in the vital data history related to the designation day over time. Accordingly, the event criteria information may be as shown in FIG. 14. FIG. 14 shows event criteria information related to vital data regarding blood pressure, and different event criteria information may be provided for each vital data that needs to be displayed. In the event criteria, information 540a shown in FIG. 14, for example, with respect to health care guidance event, in the period determining conditions, it is stated that if there is a day of occurrence of the health care guidance event (guidance day) around the designation day, the display period is set to a period around the designation day including the guidance day. If the guidance day is not around the designation day, but is well before the designation day, the display period is set to 30 days from the guidance day. Note that if there is only a vital data history of 15 days or less from the guidance day that can be displayed, the display period is set to 30 days from the date of occurrence of a health care guidance event before the previous health care guidance event (guidance day). In the manner described above, the counselor can set conditions for specifying the display period to which the subject's attention should be drawn as the event criteria information. In Embodiment 1, the subject terminal 100 is configured such that it cannot update the event criteria information, but may be configured to be capable of updating the event criteria information, as with the counselor terminal 300. This configuration enables the subject to set a period that needs to be displayed in the vital data history displayed in a graph format. The predetermined criteria used to select a vital data display duration period may be in the form of information (data) such as the event criteria information or may be in the form of an algorithm embedded in the control program.

In Embodiment 1, only one subject terminal shown, but the health management system may include a plurality of subject terminals for different subjects. In the case where the health management system includes a plurality of subject terminals, the plurality of subject terminals are identified by using identification information of each subject terminal or each subject, and the vital data history, the detailed information, the event history and the event criteria information are handled separately for each subject. In the case of updating event criteria information related to predetermined criteria by using the counselor terminal, the event criteria information may be updated individually for each subject through an input from the counselor, or alternatively, the event criteria information may be updated collectively for all of the subjects through an input from the counselor.

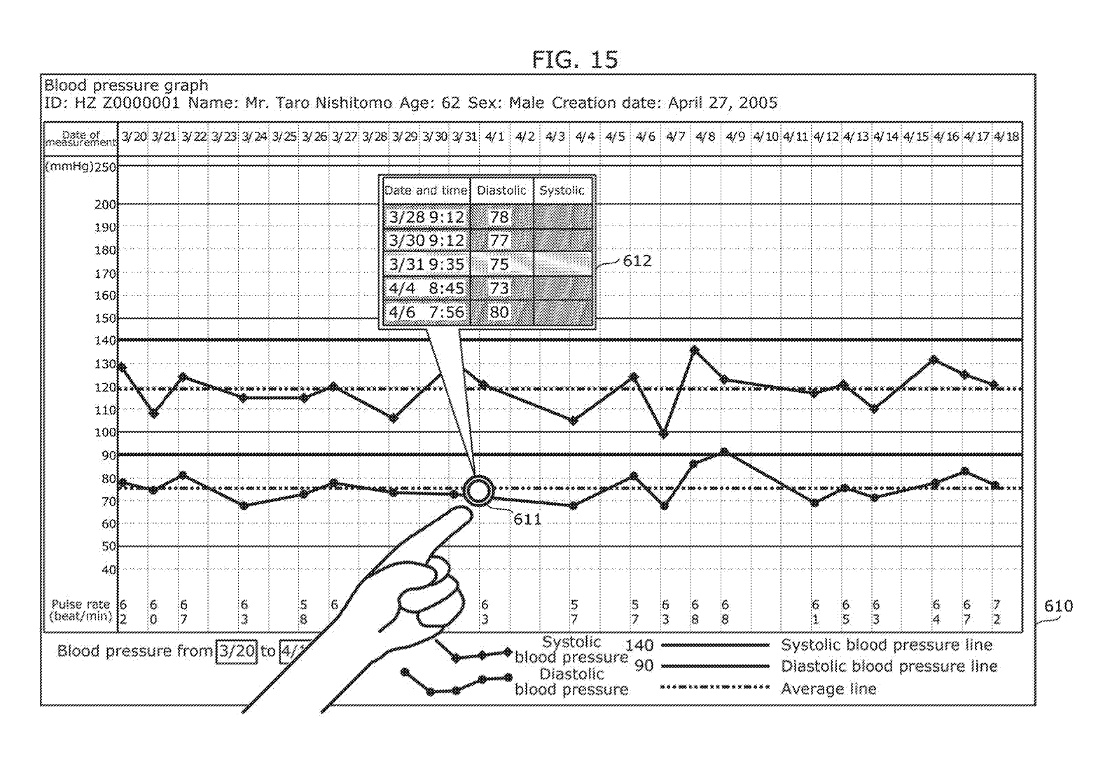

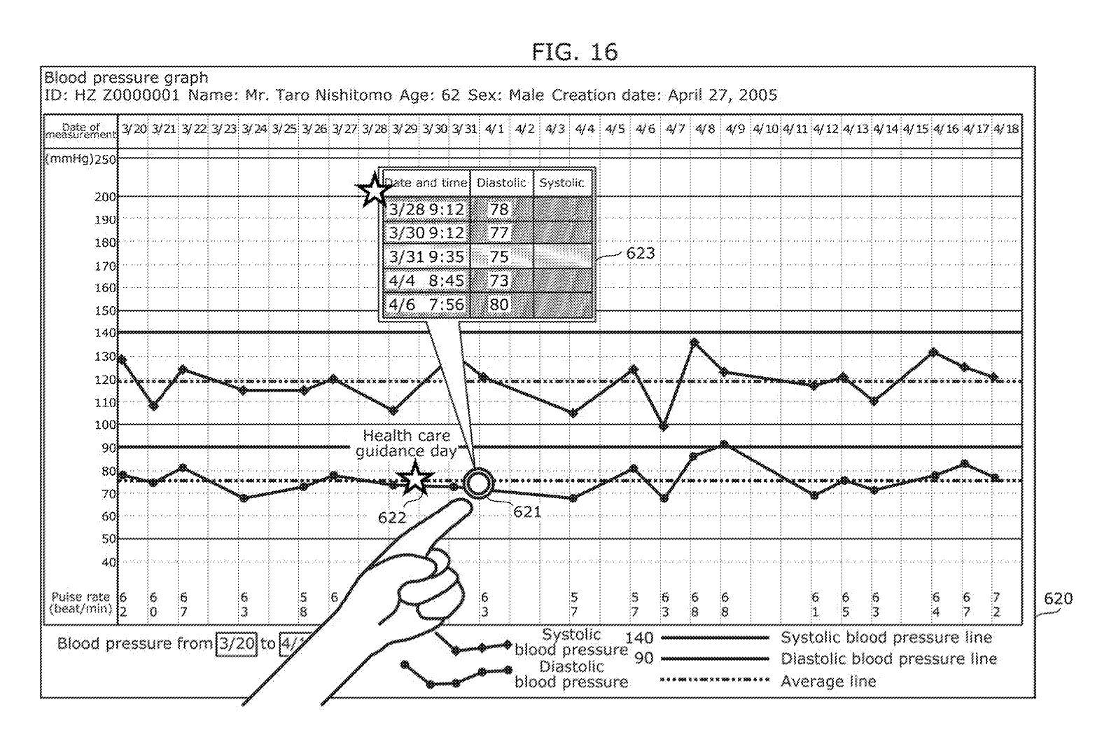

In Embodiment 1, a configuration is shown in which when a user (subject) makes a designation on a vital data history displayed in a tabulated format on the subject terminal 100, a certain range of the vital data history is displayed in a graph format (see FIGS. 8 and 9). However, it is also possible to use a configuration in which as in a screen 610 shown in FIG. 15, when a portion 611 on the graph is designated by the subject while the vital data history is displayed in a graph format, a window 612 displaying a certain range of the vital data history in a tabulated format pops up on the screen. FIG. 15 shows an example of a screen in the case where the subject terminal 100 is a tablet having a relatively wide screen. The subject terminal 100 may be configured to, instead of being configured to switch the display between a tabulated format and a graph format as shown in FIG. 8, display vital data in a tabulated format such that the vital data in a tabulated format is superimposed on a portion of the screen in which a vital data history is displayed in a graph format as shown in FIG. 15. Conversely, the subject terminal 100 may be configured to display vital data in a graph format such that the vital data displayed in a graph format is superimposed on a portion of the screen in which the vital data history is displayed in a tabulated format. That is the subject terminal 100 may be configured to hide at least a portion of the display region in which a vital data history is already displayed in a certain format and display the vital data history in a different format on the hidden portion. The window 612 shown in FIG. 15 displays a vital data history of several days (several records) around the vital data (measured values) measured on March 31, which is the date designated at the portion 611. The vital data history may be displayed in a narrowed time range based on the event criteria information. That is, as in a screen 620 shown in FIG. 16, the vital data history in a narrowed range corresponding to the influence period of an event (health care guidance event in this example) that influences the date (March 31) specified at a portion 621 on the graph designated by the subject may be displayed on a window 623. In this case, the time range of the vital data history displayed in a tabulated format on the window 623 is specified through the display period specifying processing shown in FIG. 10.

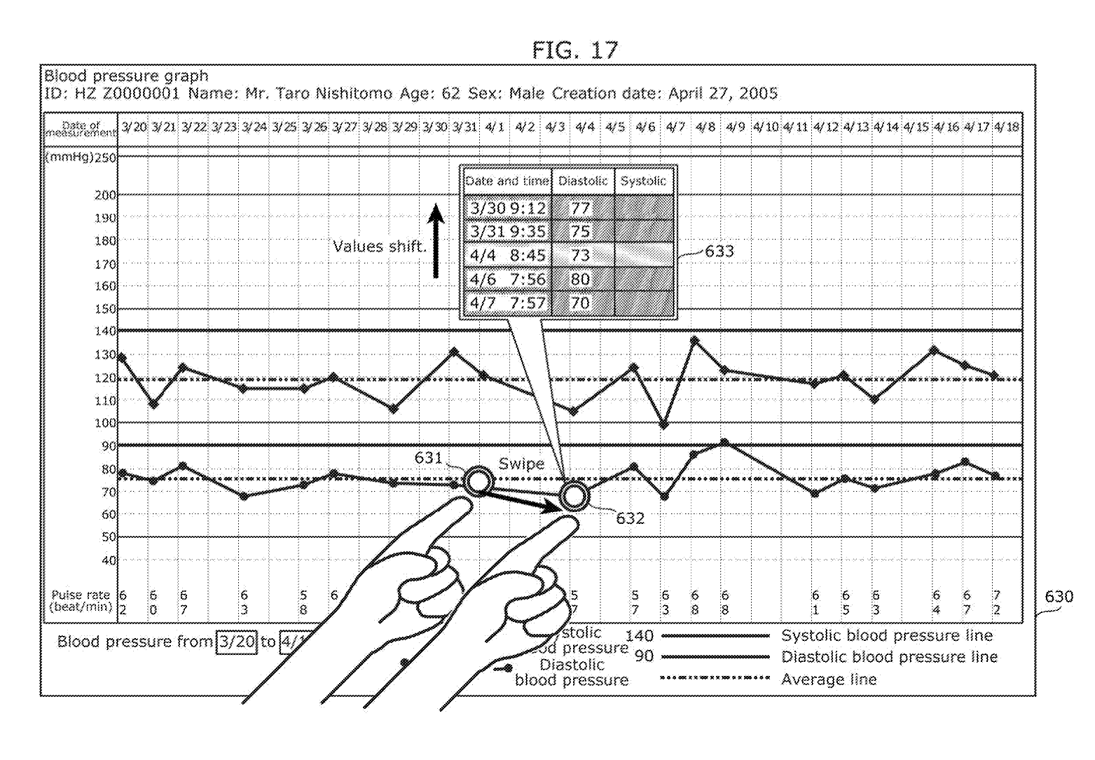

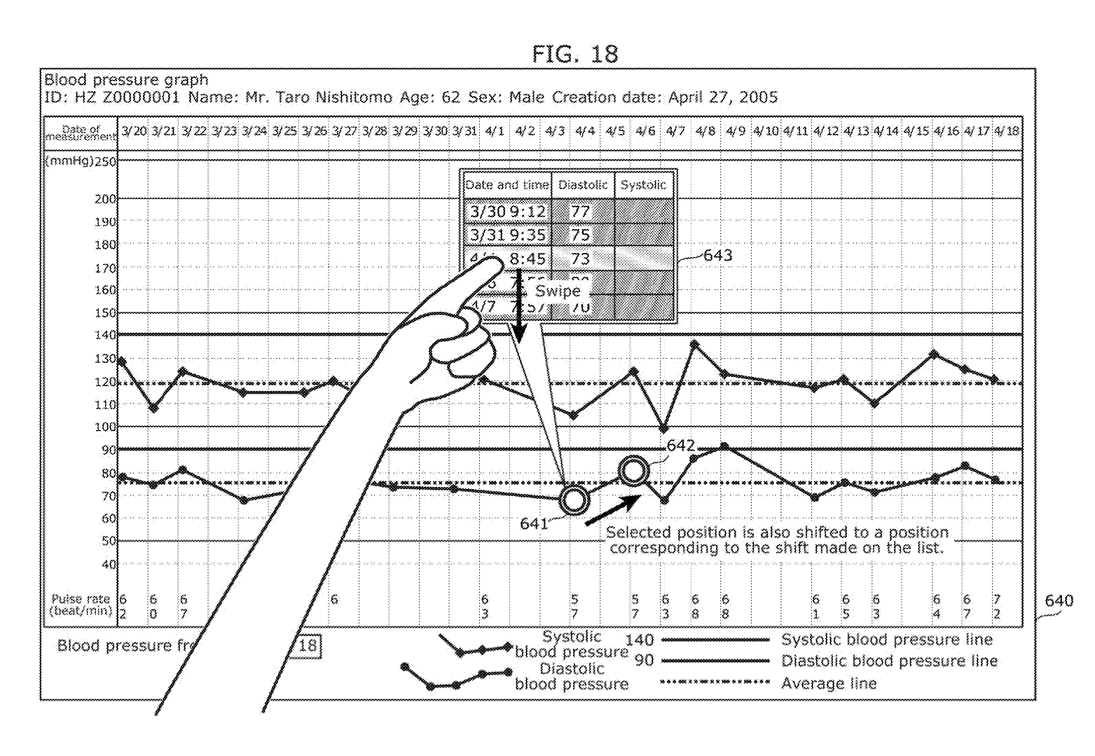

It is also possible to use a configuration in which, as shown in FIG. 17, when a so-called swipe operation is performed by the user, or in other words, when the user moves a touch position from a portion 631 on the graph to a portion 632 on a screen 630, the range of vital data history in a tabulated format displayed in a window 633 is changed along with the movement. Conversely, it is also possible to use a configuration in which, as shown in FIG. 18, when a swipe operation is performed by the user touching a portion of the vital data history in a tabulated format displayed on a window 643 on a screen 640, a mark indicating an attention point on the graph is moved accordingly.

The health management system described in Embodiment 1 includes a subject terminal 100, a management apparatus 200 and a counselor terminal 300, but does not necessarily include the counselor terminal 300. In addition, the health management system may be configured by a subject terminal alone. In the case where the health management system is configured by a subject terminal alone, it is sufficient that the subject terminal has the same configuration as the subject terminal 100 shown in Embodiment 1. However, it is necessary to store in advance, in the event criteria storage unit 104, externally acquired event criteria information or pre-defined event criteria information. Also, in the case where the health management system is configured by using a subject terminal alone, the communication unit 110 may be omitted. Also, the vital data storage unit 101, the detailed information storage unit 102, the event storage unit 103 and the event criteria storage unit 104 may be areas of a storage medium (for example, a hard disk device or the like) other than the memory.

In Embodiment 1, an example is shown which the time range displayed when the display is switched from one format (first format) to another format (second format), or in other words, between a tabulated format and a graph format, is limited (see FIG. 8). Then, in FIGS. 15 to 18, examples are shown in which when the display in the second format is superimposed on the display in the first format, the time range that is superimposed and displayed is limited. As described above, the first format and the second format can be set such that the first format is a tabulated format and the second format is a graph format, or the first format is a graph format and the second format is a tabulated format. Other than this, the first format and the second format can be set such that the first format and the second format are graphs of mutually different types such as a bar chart and a line graph. Switching the display format from the first format to the second format or the display in the second format is added in a superimposed manner) in response to an operation performed by the user (subject) while data is displayed in the first format leads to an increase in the number of items that can be recognized by the user by using the feature of each format. For example, the tabulated format is useful for the user to check data values, and the graph format (line graph or the like) is useful for the user to recognize the tendency of changes in data over time. With the health management system according to the present disclosure, the data to be displayed is limited to those to which attention needs to be paid at the time when the display format is switched (or the display in another format is added). By doing so, the possibility that the user can accurately recognize the data is increased. Accordingly, the user can efficiently view useful information with a less number of operations.

Also, the event occurrence mark in the form of a star described in Embodiment 1 is merely an example, and the event occurrence mark that indicates the date and time of occurrence of an event may be any display object to be displayed (characters, symbols, marks such as graphics, icons, images and the like). Also, although health care guidance, physical exercise, eating-out and restricted diet are used as examples of events, the events can be any phenomena as long as they may influence the vital data. Also, only one type of event may be handled as the event. As examples of vital data, blood pressure, blood sugar level, weight, the number of steps of walking are used, but any other vital data may be used. It is also possible to handle only one type of vital data as the vital data.

Also, in Embodiment 1, the display control unit 160 is configured to generate screen data for displaying a vital data history needs to be displayed in a tabulated format or a graph format, but a configuration is also possible in which the management apparatus 200 generates screen data and the display control unit 160 acquires and displays the generated screen data.

Also, the order in which the steps of the information processing method (the processing operations shown in FIGS. 9 to 13) of the health management system 10 according to Embodiment 1 are executed need not necessarily be limited to the order described in Embodiment 1, and the order in which the steps are executed is interchangeable within a scope that does not depart from the gist of the invention.

Also, various functional structural elements of the devices included in the subject terminal 100, the management apparatus 200 or the counselor terminal 300 described in Embodiment 1 may be provided in separate devices. The various functional structural elements in the separate devices may perform operations in cooperation by performing wired or wireless communication with each other, and it is thereby possible to implement the same information processing method as that implemented by the subject terminal 100, the management apparatus 200 or the counselor terminal 300 described in Embodiment 1.

Also, the functional structural elements (functional blocks) of various devices included in the health management system 10 may be individually integrated on a single chip by a semiconductor device such as an integrated circuit (IC) or a large scale integration (LSI), or may be integrated on a single chip so as to include a part or all of the functional structural elements. The method for integration on an integrated circuit is not limited to an LSI, and the integration on an integrated circuit may be implemented by a dedicated circuit or a general-purpose processor. It is also possible to use a field programmable gate array (FPGA) that can be programmed after LSI production or use a reconfigurable processor that enables reconfiguration of the connection and setting of circuit cells in the LSI. Furthermore, if a technique for integration on an integrated circuit that can replace LSIs appears by another technique resulting from the progress or derivation of semiconductor technology, the functional blocks may be integrated by using that technique. Application of biotechnology or the like is possible.

A part or all of the various processing operations performed by various devices described above (the processing operations shown in FIGS. 9 to 13 and the like) may be implemented by hardware of the various devices or may be implemented by using software. The processing implemented by software can be implemented by the processors included in the various devices executing control programs stored in the memories. Also, the control programs may be recorded in recording media and then distributed or spread. It is possible to cause the devices to perform various processing operations (the processing operations shown in FIGS. 9 to 13 and the like) by installing the distributed control programs on the devices and causing the processors of the devices to execute the control programs.

Although only an exemplary embodiment of the present invention has been described in detail above, those skilled in the art will readily appreciate that many modifications are possible in the exemplary embodiment without materially departing from the novel teachings and advantages of the present invention. Accordingly, all such modifications are intended to be included within the scope of the present invention.

### INDUSTRIAL APPLICABILITY

The present disclosure is applicable to a system that displays information for health management.

1. A health management system that provides a display based on vital data acquired from a subject, the health management system comprising:
a vital data storage unit configured to store a vital data history of vital data associated with a time when the vital data was acquired;
an event storage unit configured to store an event history indicating a time of occurrence of an event that possibly influences the vital data;
a display control unit configured to display the vital data history in a first format;
a designation accepting unit configured to accept a designation operation while the vital data history is displayed in the first format; and
a specifying unit configured to specify a time related to the designation operation accepted by the designation accepting unit and specify a time range, during which an influence is exerted by an event that influences vital data corresponding to the specified time, based on the event history and predetermined criteria,
wherein the display control unit is configured to, when the designation operation is accepted by the designation accepting unit, display a vital data history corresponding to the time range specified by the specifying unit in a second format that is different from the first format.

2. The health management system according to claim 1,
wherein the health management system is implemented by including a subject terminal and a management apparatus that perform communication with each other,
the subject terminal includes the display control unit, the designation accepting unit, and an acquiring unit configured to acquire the vital data and reflect the acquired vital data to the vital data history stored in the vital data storage unit,
the management apparatus includes the vital data storage unit and the event storage unit,
the first format is a tabulated format and the second format is a graph format, and
the predetermined criteria is information indicating a period during which the event influences the vital data.

3. The health management system according to claim 2, further comprising a counselor terminal that performs communication with the management apparatus,
wherein the event belongs to one of a plurality of event types,
the predetermined criteria is information indicating, for each event type, a degree of importance of the event and a period during which the event influences the vital data,
the counselor terminal includes an input accepting unit configured to accept an input operation for inputting guidance information indicating a guidance instruction provided to the subject based on the vital data stored in the vital data storage unit and an input operation for updating the predetermined criteria,
the management apparatus includes a detailed information storage unit configured to store the guidance information,
the event types include health care guidance in which the guidance information is notified to the subject,
the event history indicates, in a case of the event belonging to the health care guidance, a time when the guidance information was notified to the subject and includes information being associated with the guidance information stored in the detailed information storage unit, and
the display control unit is configured to display the guidance information if a predetermined condition is satisfied,

4. The health management system according to claim 3,
wherein the acquiring unit is further configured to:
acquire event information regarding an event related to an activity input by the subject and update the event history stored in the event storage unit based on the event information; and
when the event information acquired by the acquiring unit includes a comment regarding the event, store the comment in the detailed information storage unit,
when there is a comment regarding the event related to the activity, the event history includes information that is associated with the comment stored in the detailed information storage unit, and
the display control unit is configured to display the comment if a predetermined condition is satisfied.

5. The health management system according to claim 3,
wherein the designation accepting unit is configured to also accept a designation operation when the vital data history is displayed in the graph format, and
the display control unit is configured to:
display the vital data history with a display object indicating the time of occurrence of the event when displaying the vital data history in the graph format; and
when a designation operation for designating the display object is accepted by the designation accepting unit, determine that the predetermined condition has been satisfied.

6. The health management system according to claim 3,
wherein the designation accepting unit is configured to also accept a designation operation when the vital data history is displayed in the graph format, and
the display control unit is configured to display the vital data history corresponding to the time range specified by the specifying unit in the tabulated format when the designation operation is accepted by the designation accepting unit while the vital data history is displayed in the graph format.

7. The health management system according to claim 1,
wherein the acquiring unit is further configured to acquire event information regarding an event related to an activity input by the subject and reflect the acquired event information to the event history stored in the event storage unit.

8. The health management system according to claim 2,
wherein the acquiring unit is further configured to accept an input operation for updating the predetermined criteria and update the predetermined criteria.

9. The health management system according to claim 1,
wherein the health management system is implemented by including a subject terminal and a management apparatus that perform communication with each other,
the subject terminal includes the display control unit, the designation accepting unit, and an acquiring unit configured to acquire the vital data and reflect the acquired vital data to the vital data history stored in the vital data storage unit,
the management apparatus includes the vital data storage unit and the event storage unit,
the first format is a graph format and the second format is a tabulated format, and
the predetermined criteria is information indicating a period during which the event influences the vital data.

10. The health management system according to claim 1,
wherein the first format is a tabulated format and the second format is a graph format,
the predetermined criteria is information indicating a period during which the event influences the vital data, and
the specifying unit is configured to, when the designation accepting unit accepts a designation operation for designating vital data while the vital data history is displayed in the tabulated format, specify a time when the vital data designated by the designation operation was acquired, and if the time is included in a period during which an influence is exerted by an event that occurred prior to the time, specify the period as the time range.

11. The health management system according to claim 1,
wherein the event belongs to one of a plurality of event types,
the predetermined criteria is information indicating, for each event type, a degree of importance of the event and a period during which the event influences the vital data, and
the specifying of the time range performed by the specifying unit is specifying of a time range, during which an influence is exerted by an event having a highest degree of importance among events that influence vital data corresponding to the time related to the designation operation.

12. The health management system according to claim 1,
wherein the display control unit is configured to, when displaying the vital data history in the second format, hide at least a portion of a display region in which the vital data history is already displayed in the first format and display the vital data history in the second format on the hidden portion.

13. The health management system according to claim 1, further comprising
a detailed information storage unit configured to store detailed information that is information containing details of the event,
wherein the display control unit is configured to:
display a display object by referencing the event history; and
display the detailed information stored in the detailed information storage unit when a designation operation for designating the display object is accepted by the designation accepting unit.

14. An information processing method for use in a health management system that includes an apparatus including a storage medium and a processor and that provides a display based on vital data acquired from a subject, the method comprising the following performed by the processor:
storing, in the storage medium, a vital data history of vital data associated with a time when the vital data was acquired and an event history indicating a time of occurrence of an event that possibly influences the vital data;
displaying the vital data history in a first format;
accepting a designation operation while the vital data history is displayed in the first format;
specifying a time related to the accepted designation operation and specifying a time range, during which an influence is exerted by an event that influences vital data corresponding to the specified time, based on the event history; and
when the designation operation is accepted, displaying the vital data history corresponding to the specified time range in a second format that is different from the first format.

15. A non-transitory recording medium having a control program recorded thereon for causing a processor to execute information processing,
the processor being included in an apparatus for use in a health management system that provides a display based on vital data acquired from a subject,
the information processing comprising:
referencing a vital data history of vital data associated with a time when the vital data was acquired and an event history indicating a time of occurrence of an event that possibly influences the vital data;
displaying the vital data history in a first format,
accepting a designation operation while the vital data history is displayed in the first format;
specifying a time related to the accepted designation operation and specifying a time range, during which an influence is exerted by an event that influences vital data corresponding to the specified time, based on the event history; and
when the designation operation is accepted, displaying the vital data history corresponding to the specified time range in a second format that is different from the first format.
